(19) United States
(12) Patent Application Publication
(10) Pub. No.: US 2010/0002322 A1
(43) Pub. Date: Jan. 7, 2010

(54) Discrete CYM filter with hue and saturation changes

(75) Inventor: James Bornhorst, Dallas, TX (US)

Correspondence Address: Law Office of Scott C Harris Inc, PO Box 1389, Rancho Santa Fe, CA, 92067, US

(73) Assignee: PRODUCTION RESOURCE GROUP L.L.C, New Windsor, NY (US)

(21) Appl. No.: 12/493,206

(22) Filed: Jun. 28, 2009

Related U.S. Application Data
(60) Provisional application No. 61/076,724, filed on Jun. 30, 2008.

(51) Int. Cl. G02B 5/22

(52) U.S. Cl. 359/891

(57) ABSTRACT

Discrete CYM filter has discrete filter elements that create a color set over a color range. The color range changes both hue and saturation between adjacent color filter elements, thus making the elements and their resultant colors, look more “interesting”.

This application claims priority from application Ser. No. 61/076,724, filed Jun. 30, 2008, the entirety of the disclosure of which is herewith incorporated by reference.

### BACKGROUND

CYM filter-based coloring of light is carried out according to additive or subtractive filtering. A typical way in which projected light is colored uses subtractive filtering between a cyan, magenta, and yellow coloration.

### SUMMARY

Color filters are arranged to create effects in color space.

In one exemplary embodiment, the a set of color filters which is mounted to filter light using one filter of the set, to another filter of the set, wherein the color filters form a progression of colors within a color space, and where the progression of colors changes both the hue and also the saturation of filtered colors in the progression in the color space.

In another embodiment, the progression of colors creates a non-straight line in the progression in color space.

### BRIEF DESCRIPTION OF THE DRAWINGS

FIG. 1 shows a CIE chromaticity diagram;

FIG. 2 shows a lighting system formed from multiple discrete filters;

FIG. 3 shows a CIE chromaticity diagram and how the filters can progress through the diagram;

FIG. 4 illustrates an exemplary color wheel; and

FIG. 5 shows a split beam effect.

### DETAILED DESCRIPTION

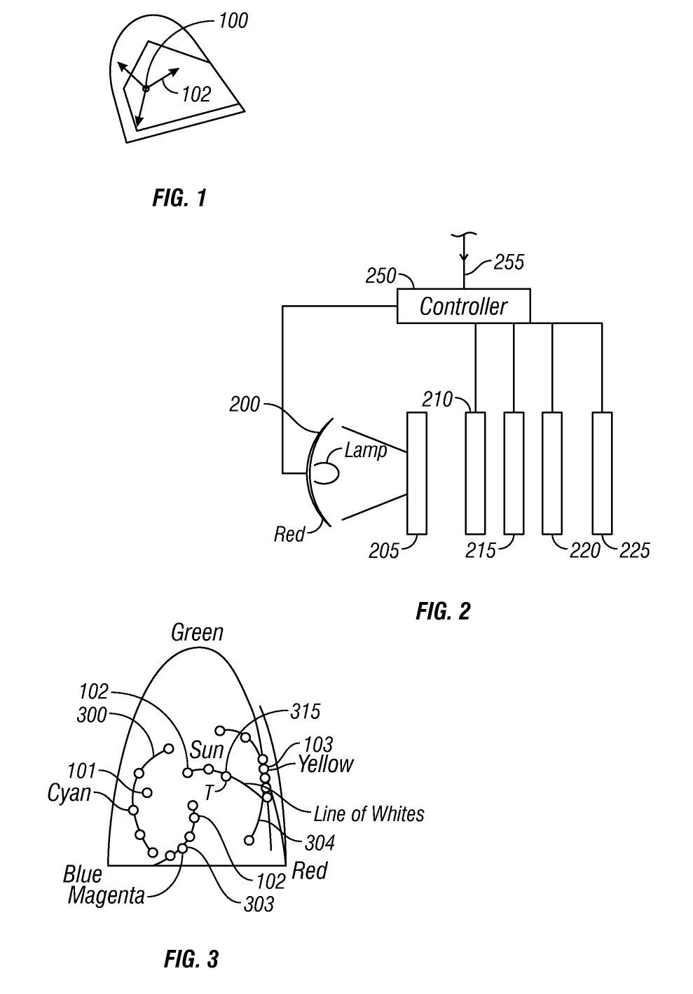

FIG. 1 illustrates a CIE chromaticity diagram, showing the standard filters of cyan, magenta, and yellow filters. Filters are formed by patterning wheels to obtain areas of varying saturation. The wheels vary between a first clear area, and a second mildly-saturated area, varying up to an area of maximum saturation.

The inventor noticed, however, that while the saturation varies in these areas, the hue of the wheel is typically the same in all of these areas. Only the saturation attributable to the wheel changes.

In reality, however, the inventor recognizes that color is formed of hue, plus saturation, plus intensity. In a typical prior art filter, only saturation changes. When plotting this within the chromaticity diagram, it means that the progression of colors in the chromaticity diagram can only move radially through the chromaticity diagram as shown as 102 in FIG. 1. Only the saturation can change can only occur in this radial direction relative to the system white point shown as 100. Also, the final intensity can be dimmed by a dimmer, but this does not change the hue of the coloration.

In these conventional systems, as the wheel changes saturation, it moves the color in only these straight lines 102 through the diagram. Upon noticing that the saturation always moves in a straight line, the inventor believes that this makes the color set look less interesting.

Multiple color wheels can be used to mix the colors. This produces a united color space defined by all of the CYM filters.

An embodiment uses a different technique. Instead of using a CYM graduated filter of this type, an embodiment uses special discrete CYM filters which have been selected to traverse more of the color space.

A view of a lighting system is shown in FIG. 2, where the lamp/reflector 200 is optically processed by optical filtering 205, for example which may be a heat shield device such as a dark mirror. This is followed by three discrete CYM color wheels 210, 215, and 220. These color wheels are followed by a second color wheel 225 which is a “designer” color wheel.

Each of the color wheels uses sets of filters that vary both hue and saturation of the colors to provide a trajectory in the color space representing by the chromaticity diagram, that travels throughout the CYM color space over a large area.

The lamp may be a commercial stage lighting lamp, where the light output is greater than 1000 lumens. Functions of the lamp are controlled by a controller 250, which may be a computer based device, operating based on a remotely received command 255, that is received over a network.

For example, FIG. 3 illustrates how in place of the linearly variable filters, there can be multiple discrete filters, for each of C, Y and M, which collectively follow a curved trajectory 300, 303, 304 in the CYM color space. In place of the straight line representing the cyan filter, there can be a curved path 300 through the color space. In place of the straight line representing the yellow filter, there can be a curved path 304 through the color space. The magenta filter 102 is replaced by discrete filters that are set along a curved path 303. The filters of the embodiment are selected to have transmission accuracy and to provide large variations in color space. By choosing a set of discrete filters that lie on the path in the curve, they have both hue and saturation that change. This allows a better and more interesting range of colors, and still allows many of the features that have been found interesting in lighting effects, such as cross fading. Because this system allows a number of different colors on a wheel, quantized cross fading can be carried out.

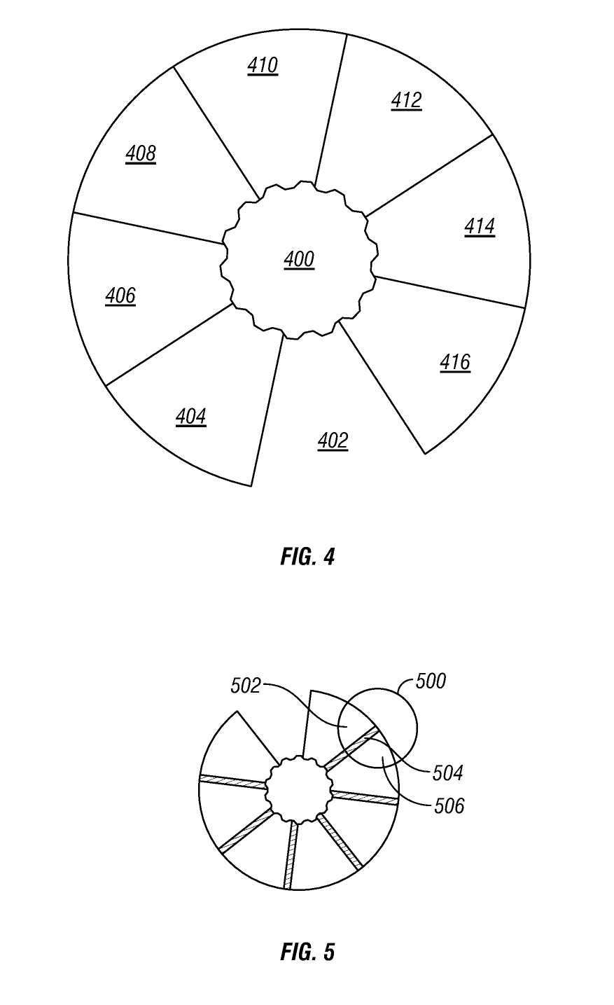

FIG. 4 illustrates an exemplary embodiment of a color wheel, which is formed of a central hub 400, that defines an open spot 402. There are also a number of discrete color parts 404, 406, 408, 410, 412, 414 and 416. Each of these color parts has a different relationship.

According to one embodiment, the area over which color is desired to be covered is defined in terms of a beginning point a, and an ending point b. There is a nonlinear relationship between the different color filters in the set between a and b. More specifically, at least for the cyan and yellow wheels, a multiplier of the nth root of (b−a) becomes the multiplier for each of the next filters, thereby forming a geometric relationship between each filter and the next filters. That is, filter 2=filter 1*(nth root) of (B−A). Filter 3 is equal to filter 2*(nth root) of (B−A). This provides a geometric relationship between the filters. These values may be selected or found using a computer program, for example.

In the embodiment, the magenta wheel may be selected to create a curve in the area where the magenta color might be found. However, magenta may be very nonlinear towards the bottom end, as shown, where the top end of the progression is a curve with more curve ability than the bottom end.

This system provides a discrete CYM system that varies both hue and saturation. In addition, each filter element such as 404 is even over the entire beam, providing a color that is very even over the entire beam.

The embodiment also allows special effects. A beam spot shown in FIG. 5 is produced by the lamp/reflector 200 as 500. This beam spot may be located in a position where it is colored by three separate colors from three separate color wheels 502, 504 and 506 which intersect the beam at the same time.

Another embodiment provides the ability to display a tri-split colored beam, something that has not been possible in any of the cited prior art. For example, the part 502 may be an edge with an opening next to it, or a wheel that has a low saturation filter next to it. The next part 504 may be from a different wheel, either additive with two open spots for additive parts, with two low saturation spots on the other wheel. 506 may be yet another part.

The embodiment may use a tungsten source lamp, which produces an output for example at the spot 315 in FIG. 3.

Another embodiment describes how the filters in the set are each varying in both hue and saturation from a previous filter in the set, and the filters in the set also always differ in a single direction. The filters in the sets have progressive hues which always increase in a certain direction and increasing saturations which always increases in a certain direction through the set.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of lighting devices can be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A color changing system comprising:
a set of color filters which is mounted to filter light using filters of the set, wherein each said color filter forms a progression of colors within a color space, and where said progression of colors within said filters changes both the hue and also the saturation of filtered colors in the progression in color space.

2. A system as in claim 1, wherein said color filters are located on a color wheel which is rotatable and which has a number of said color filters thereon forming the set.

3. A system as in claim 2, wherein said wheel includes a rotatable hub, and a number of filters arranged around the hub, and where said filters and their order, form said progression of colors.

4. A system as in claim 1, wherein said progression of colors have hues which always increase in a first direction passing from one color filter to another color filter, and saturations which always increase in a second direction, where said first direction and said second direction can be the same or different directions.

5. A system as in claim 1, wherein said color filters have values in chromaticity space which form a non-straight line through said chromaticity space.

6. A system as in claim 1, wherein said color filters collectively form a color set, and where there is a nonlinear relationship said color filters in said color set extending from a beginning point of the color set to an ending point of the color set.

7. A system as in claim 6, wherein said color filters form a relation where any filter n in the set extending from filter 1 to filter x has a value of filter n=filter (n−1)*(nth root of) (filter x−filter 1).

8. A color changing system comprising:
a set of filters on a holder, in an order, wherein said color filters in said order form a progression of colors within a color space, and where said progression of colors creates a non-straight line in the progression in color space.

9. A system as in claim 8, wherein said color filters are located on a color wheel which is rotatable and which has a number of said color filters thereon forming the set.

10. A system as in claim 9, wherein said wheel includes a rotatable hub, and a number of filters arranged around the hub, and where said filters and their order, form said progression of colors.

11. A system as in claim 8, wherein said color filters change both the hue and also the saturation of filtered colors of filters in the color space.

12. A system as in claim 8, wherein said wheel includes a rotatable hub, and a number of filters arranged around the hub, and where said filters and their order, form said progression of colors.

13. A system as in claim 8, wherein said progression of colors have hues which always increase in a first direction passing from one color filter to another color filter, and saturations which always increase in a second direction, where said first direction and said second direction can be the same or different directions.

14. A system as in claim 8, wherein said color filters collectively form a color set, and where there is a nonlinear relationship between said color filters in said color set extending from a beginning point of the color set to an ending point of the color set.

15. A system as in claim 14, wherein said color filters form a relation where any filter n in the set extending from filter 1 to filter x has a value of filter n=filter (n−1)*(nth root of) (filter x−filter 1).

16. A system as in claim 8, wherein said filters are mounted such that part of two filters can be in the beam simultaneously.

17. A system as in claim 8, wherein said color filters collectively form a color set, and where there is a geometric relationship between said color filters in said color set extending from a beginning point of the color set to an ending point of the color set.

18. A method comprising:
arranging a first set of color filters to filter light using one area on the set, where each area has a different color filtering characteristic, and where the first set forms a progression of colors within a color space, and where said progression of colors changes both the hue and also the saturation of filtered colors in the progression in color space; and
projecting light through said one area at a first time to color said light using a first color at said area;
moving said set to a second area at a second time, and projecting light through said second area at said second time to color said light using a second color at said area.

19. A method as in claim 18, wherein said arranging comprises arranging said color filters on a color wheel which is rotatable and which has a number of said color filters thereon forming the set.

20. A method as in claim 19, wherein said wheel includes a rotatable hub, and a number of filters arranged around the hub, and where said filters and their order, form said progression of colors.

21. A method as in claim 18, wherein said progression of colors of said first set have hues which always increase in a first direction passing from one color filter to another color filter, and saturations which always increase in a second direction, where said first direction and said second direction can be the same or different directions.

22. A method as in claim 18, wherein said color filters have values in chromaticity space which form a non-straight line through said chromaticity space.

23. A method as in claim 18, wherein said color filters collectively form a color set, and where there is a nonlinear relationship said color filters in said color set extending from a beginning point of the color set to an ending point of the color set.

24. A method as in claim 23, wherein said color filters form a relation where any filter n in the set extending from filter 1 to filter x has a value of filter n=filter (n−1)*(nth root of) (filter x−filter 1).

25. A method as in claim 18, further comprising using a computer to select values of said color filters.
